(19) United States
(12) Patent Application Publication
(10) Pub. No.: US 2004/0051013 A1
(43) Pub. Date: Mar. 18, 2004

(54) Furniture leg with article suspending projection

(76) Inventor: Charles A. Risdall, Dallas, TX (US)

Correspondence Address: THOMPSON COBURN, LLP, ONE US BANK PLAZA, SUITE 3500, ST LOUIS, MO, 63101, US

(21) Appl. No.: 10/243,697

(22) Filed: Sep. 13, 2002

(51) Int. Cl. F16M 11/16

(52) U.S. Cl. 248/188; 248/188.8; 248/677

(57) ABSTRACT

A furniture leg support is attachable to the underside of a piece of furniture, for example a tabletop, where the furniture leg support is tubular with an interior bore that receives a leg section that can be adjustably positioned in the interior bore, and where a support brace extends between the furniture leg support and the piece of furniture to reinforce the leg support, the support brace has a projection at its attachment to the leg support that can be used to suspend an article, such as an article of clothing or a backpack, from the projection.

### BACKGROUND OF THE INVENTION

(1) Field of the Invention

The present invention pertains to a furniture leg having a projection that may be used to suspend an article, for example suspend a cap, a jacket or a student's backpack from the furniture leg projection.

In particular, the present invention pertains to a furniture leg support that is attached to the underside of a piece of furniture, for example a tabletop, where the leg support is tubular with an interior bore that receives a leg section that can be adjustably positioned in the interior bore. A support brace extends between the leg support and the piece of furniture to reinforce the leg support. The brace has a projection at its attachment to the leg support and the projection can be used to suspend an article, such as an article of clothing, from the projection.

(2) Description of the Related Art

Pieces of furniture, for example schoolroom chairs, have been designed with projections or hooks on some portion of the furniture that may be employed in suspending a student's backpack or an article of clothing from the projecting hook. Typically, the hook is positioned on the furniture where it will not interfere with the comfort of the student sitting in the furniture or interfere with the student's use of the piece of furniture. Clothing or backpack suspending hooks have been employed on the back surfaces of chair backs where they will suspend an article of clothing or a backpack of the student behind the student's back.

Some prior art designs of furniture incorporating an article suspending hook or projection, and in particular schoolroom furniture, have been disadvantaged in that the addition of the projection or hook for suspending the article is positioned on the piece of furniture where it adversely effects the stability of the piece of furniture. For example, the positioning of an article suspending projection or hook on the back of a schoolroom chair could adversely effect the stability of the chair. Schoolroom furniture is typically smaller in size than, for example, office furniture. The reduced size of the furniture also reduces the furniture's weight. Suspending a backpack on the back of a schoolroom chair could cause the chair to tip over backwards if the contents of the backpack have sufficient weight.

In addition, a desirable characteristic of schoolroom furniture is that it be inexpensive. This requires the furniture to be constructed in an inexpensive manner. Adding an additional structural component to a schoolroom piece of furniture like a projection or hook for suspending articles from the furniture adds to the construction cost of the furniture. Where the construction of the piece of furniture is simplified like that of schoolroom furniture where the numbers of component parts is reduced, adding another component part like a projection or hook for a backpack could significantly increase the cost of manufacturing the piece of furniture.

### SUMMARY OF THE INVENTION

The present invention overcomes the disadvantages associated with prior art furniture employing a projection for suspending an article from the furniture by providing a furniture leg having a projection built into a structural component of the leg. By adding the projection to a structural component of the leg that is already necessary for the strength and stability of the leg, the projection for suspending articles is added to the piece of furniture without adding an additional structural component to the piece of furniture, thereby avoiding an increase in the cost of manufacturing the furniture. In addition, the projection for suspending an article is positioned on the furniture leg where it will not adversely affect the stability of the piece of furniture.

The apparatus of the invention is incorporated into an assembly that securely attaches a leg to a piece of furniture. The apparatus of the invention may be employed with various different types of furniture, for example, chairs or tables, and is described herein as being employed with a table.

In the preferred embodiment, the apparatus is constructed entirely of metal and may be employed with metal furniture or wood furniture or furniture constructed of other materials. The apparatus of the invention is basically comprised of a base, a furniture leg support, and a support brace that extends between the leg support and base.

The base is a flat planar member that has a plurality of holes therethrough that are dimensioned to receive threaded fasteners in attaching the base to a piece of furniture. In the preferred embodiment the base has a triangular configuration to fit into a corner on the underside of a table, but could have a variety of different configurations.

The furniture leg support has a length with opposite proximal and distal ends, and the leg support proximal end is secured to the base. The leg support projects from the base to the leg support distal end. In the preferred embodiment the leg support is hollow and tubular. An interior bore of the leg support is accessible through an opening at the leg support distal end. A leg section of the piece of furniture can be inserted through the leg support opening and into the interior bore. Reciprocating the leg section through the leg support of the apparatus adjusts the length of the furniture leg. An internally threaded collar with a screw threaded fastener is provided on a side of the leg support. The screw-threaded fastener can be turned to extend the fastener into the interior bore of the leg support where it will contact the leg section and hold the leg section in its adjusted position in the leg support.

A support brace is connected between the base and the leg support of the apparatus to reinforce the connection of the leg support with the base. In the preferred embodiment, the brace has a length with opposite proximal and distal ends with the proximal end connected to the base and the distal end connected to the leg support. In the preferred embodiment of the invention, the brace is an elongate rod having opposite ends and a bent intermediate portion of the rod. The bend in the intermediate portion of the rod gives the rod a V-shape or a triangular configuration, with the bend being at the apex of the V-shape or triangle and with the opposite ends of the rod being at the opposite base of the triangle. The opposite ends of the bent rod form the proximal end of the brace and are attached to the base. The brace extends from its proximal end to the distal end of the brace where the bent portion of the brace rod is secured to the side of the leg support. Thus, the bent rod of the brace and the leg support form a tripod connection with the base.

In addition to the construction of the support brace described above, the bent portion of the brace rod that is attached to the leg support is formed to produce a projection or hook that projects outwardly from the side of the leg support. The bent projection is positioned on a side of the leg support where it is unobstructed by the leg support or the base, thus providing easy access to the projection for suspending an article from the projection. In addition, the bent portion of the brace rod that forms the projection is an integral part of the rod. Thus, the bent rod serves the dual functions of reinforcing the connection of the furniture leg support to the base and providing a projection on the leg support for suspending articles such as clothing or a student's backpack. In the manner set forth above, the construction of the apparatus of the invention provides a furniture leg support that also includes a projection or hook for suspending articles from the leg support where a component part of the leg support, i.e., the support brace, serves the dual functions of reinforcing the connection of the leg support to the base and providing a projection for suspending articles from the leg support.

### BRIEF DESCRIPTIONS OF THE DRAWING FIGURES

Further features of the invention are revealed in the following detailed description of the preferred embodiment of the invention and in the drawing figures wherein:

FIG. 1 is a front perspective view of the furniture leg support apparatus of the invention;

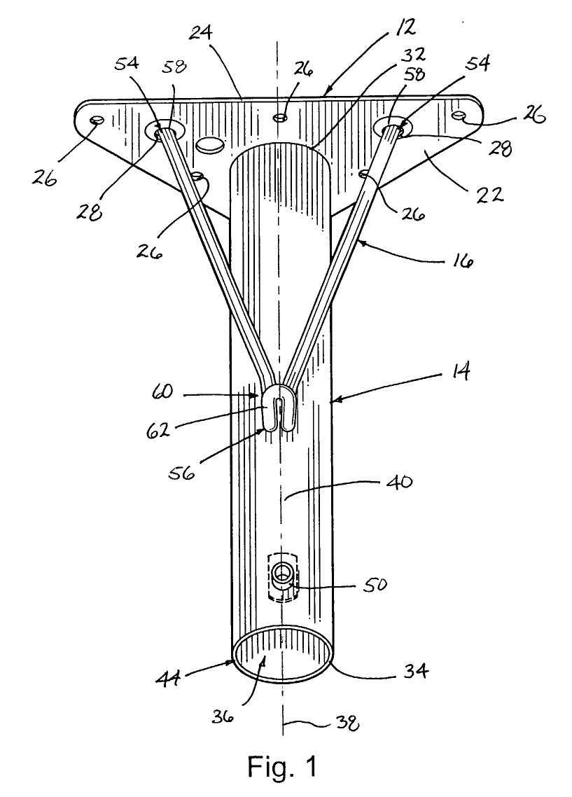

FIG. 2 is a side perspective view of the apparatus of FIG. 1;

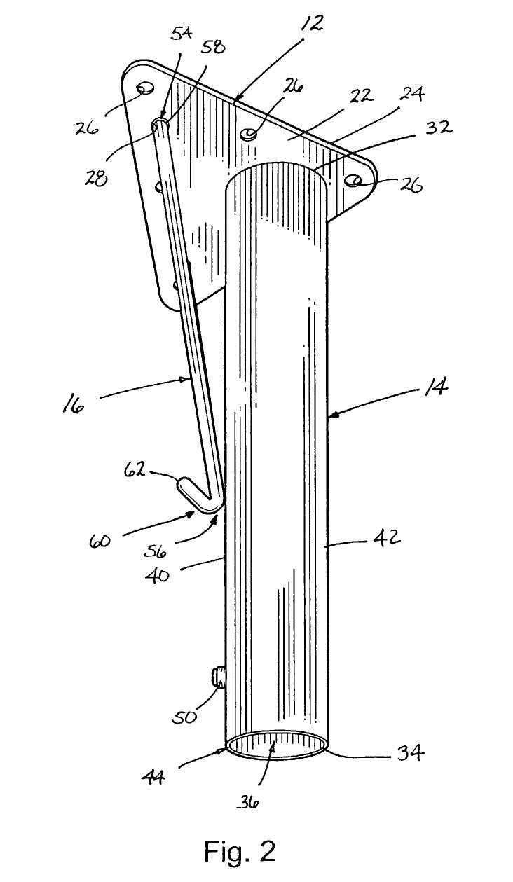

FIG. 3 is a front elevation view of the apparatus;

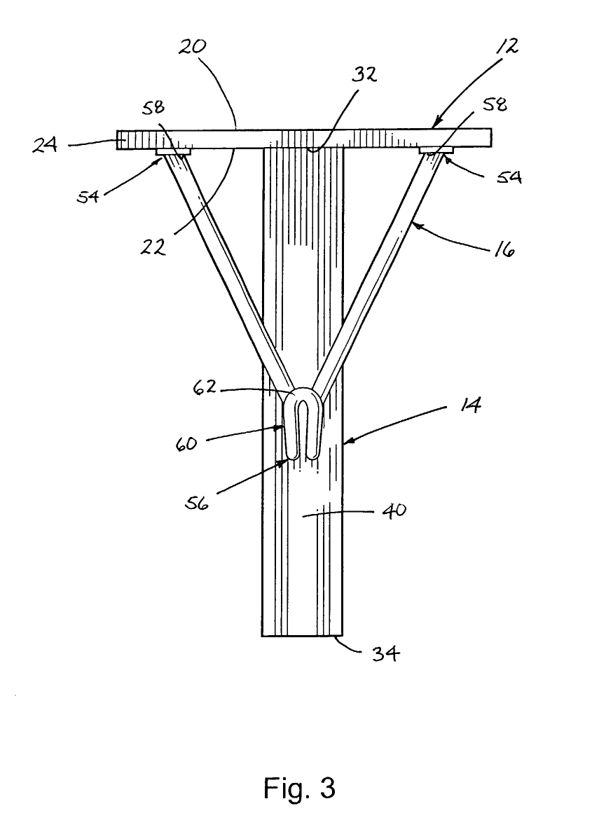

FIG. 4 is a rear elevation view of the apparatus;

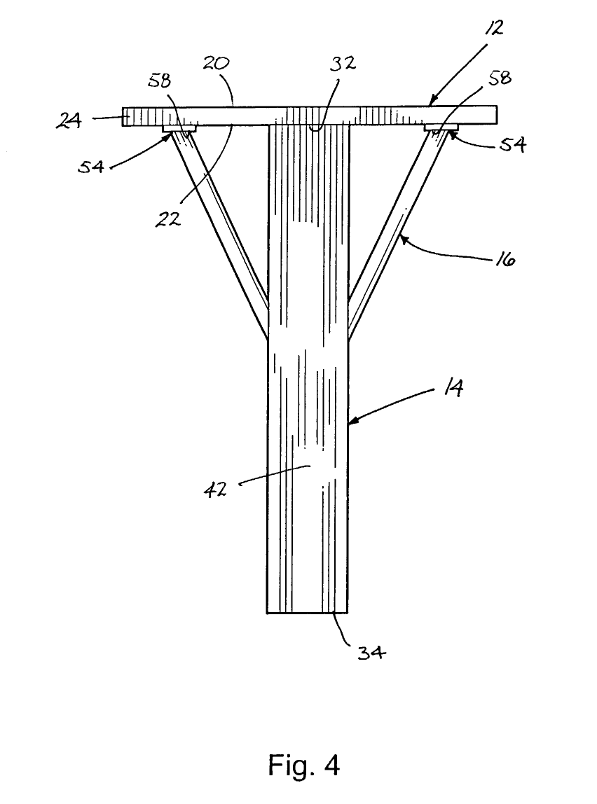

FIG. 5 is a side elevation view of the apparatus;

FIG. 6 is a top plan view of the apparatus;

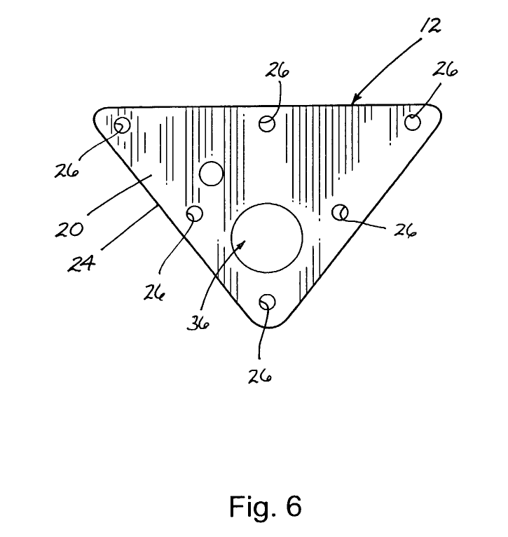

FIG. 7 is a bottom plan view of the apparatus; and,

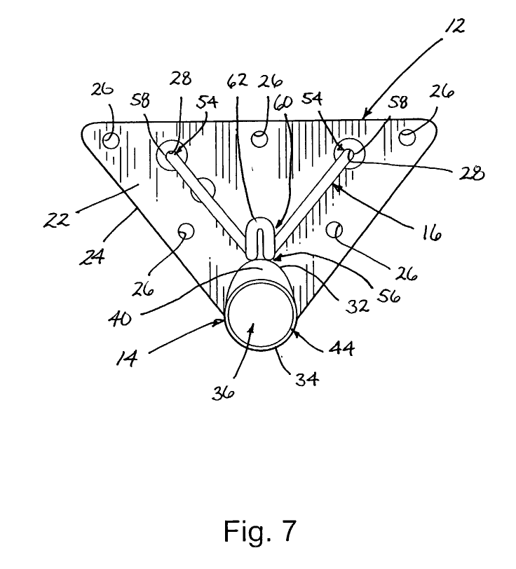

FIG. 8 is a side elevation view of the apparatus of the invention employed in the construction of a table.

### DETAILED DESCRIPTION OF THE PREFERRED EMBODIMENT

As explained earlier, the apparatus of the invention is incorporated into an assembly that securely attaches a leg to a piece of furniture and supports the leg. The apparatus of the invention may be employed with various different types of furniture, for example chairs or tables, and is described herein as being employed with a table or desk.

The apparatus of the invention is basically comprised of a base 12, a furniture leg support 14, and a support brace 16 that extends between the base 12 and the furniture leg support 14. In the preferred embodiment of the invention, each of these three component parts of the apparatus is constructed entirely of metal. The apparatus may be employed with metal furniture or wood furniture or furniture constructed of other materials. In addition, the apparatus could be constructed of materials other than metal.

The base 12 is a flat planar member, preferably a flat metal plate having opposite first 20 and second 22 surfaces. The first surface 20 of the base is the top surface as it is designed to be attached to the underside of a tabletop. The second surface 22 is the base bottom surface. However, the reference to opposite top and bottom surfaces should not be interpreted as limiting. In the preferred embodiment, the base 12 has a peripheral edge 24 that has a triangular configuration to fit into a corner of the underside of the table. The base could also have a variety of different configurations, for example a square or rectangular configuration. A plurality of holes 26 pass through the base and are provided to receive threaded fasteners in attaching the base to a piece of furniture. Other equivalent means of attaching the base to the piece of furniture could also be employed. Two holes 28 of the plurality of holes are provided for attaching the support brace 16 to the base 12, as will be explained.

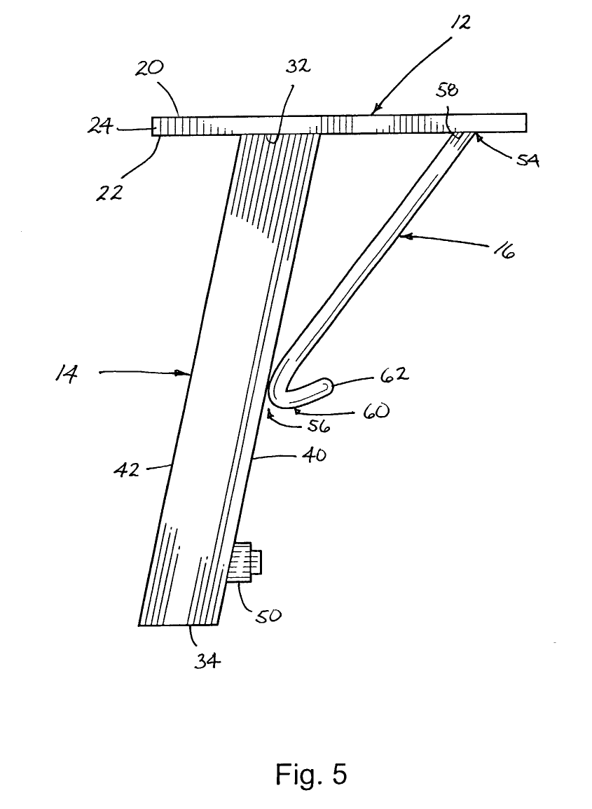

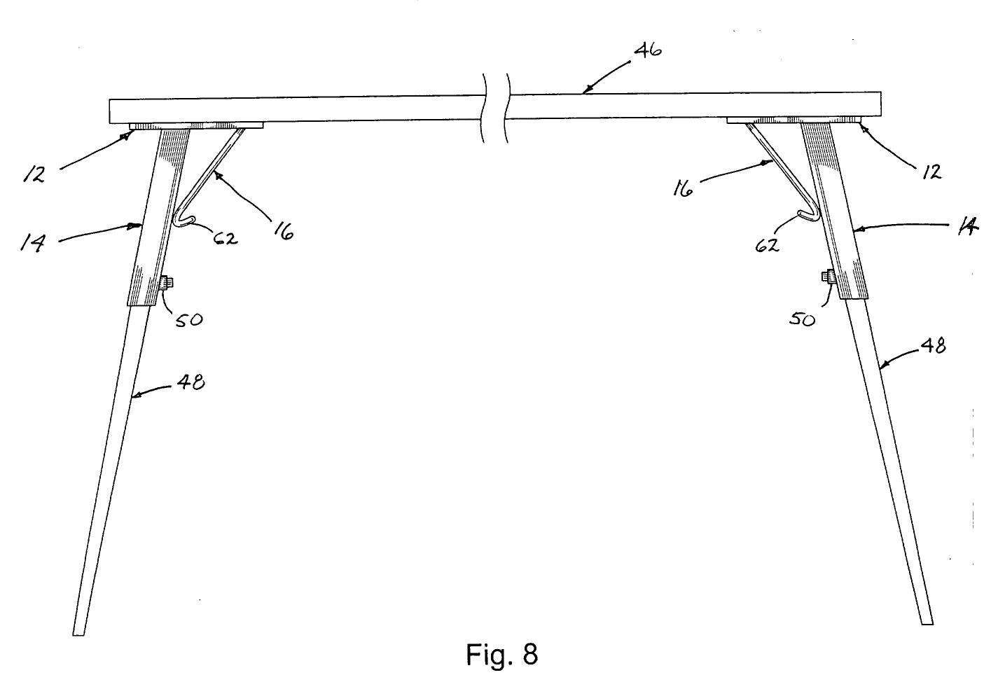

The furniture leg support 14 in the preferred embodiment is tubular and has a length with opposite proximal 32 and distal 34 ends. The tubular configuration gives the leg support 14 a hollow interior bore 36 that extends through the length of the leg support and has a center axis 38. The leg support proximal end 32 is secured to the second surface or bottom surface 22 of the base 12 by a weld or other equivalent means. The leg support 14 is secured to the base 12 in an angled orientation that is best seen in FIG. 5. The angled orientation of the leg support 14 relative to the base 12 defines and obtuse angle between a first side 40 of the leg support 14 and the base 12, and an acute angle between an opposite second side 42 of the leg support 14 and the base 12, as seen in FIG. 5. This angled orientation of the leg support 14 relative to the base 12 gives greater stability to the piece of furniture with which the apparatus of the invention is used. The leg support 14 projects from the base 12 to the leg support distal end 34 where an opening is provided into the leg support interior bore 36. The opening 44 is provided to receive a leg section of a piece of furniture inserted through the opening into the leg support interior bore 36. An example of a table 46 employing the apparatus of the invention for attaching leg sections 48 to the table is shown in FIG. 8. The length of the leg support 14 enables the leg section 48 to be reciprocated through the leg support interior bore 36 to adjust the overall length of the table leg defined by the length of the leg support 14 and the adjusted position of the leg section 48. An internally threaded collar 50 is provided on the first side 40 of the leg support. The internal screw threading of the collar 50 can receive a screw threaded fastener that can be turned to extend the fastener through the collar and into the leg support interior bore 36 to engage with a leg section 48 inserted into the bore and hold the leg section in its adjusted position in the leg support. Instead of the internally threaded collar 50, other means of adjustably positioning the leg section 48 in the leg support interior bore 36, for example mating screw threading on the exterior of the leg section and the interior of the interior bore may be employed to adjustably position the leg section in the leg support. Still further, in a variant embodiment of the apparatus of the invention the leg sections 40 could be integral extensions of the leg supports 14 where the overall lengths of the furniture legs would not be adjustable.

The support brace 60 is connected at an angle between the base 12 and the furniture leg support 14 and functions as a gusset reinforcing the connection of the leg support 14 with the base 12. As shown in the drawing figures, the brace 16 has opposite proximal 54 and distal 56 ends that are connected between the bottom surface 22 of the base and the first side 40 of the leg support. In the preferred embodiment of the invention, the brace 16 is an elongate rod having opposite ends 58 and a bent portion 60 intermediate the rod ends. The bend in the intermediate portion 60 of the rod gives the rod a V-shape or a triangular configuration with the bend 60 being at the apex of the V-shape or triangle and with the opposite ends 58 of the rod being at the opposite base of the triangular configuration. The opposite ends 50 of the rod form the proximal end of the support base 16 and are attached to the bottom surface 22 of the base in the support brace holes 28. In the preferred embodiment, the opposite ends 58 of the rod are attached to the base 12 by welds securing the brace proximal end 54 to the base, but could be secured to the base by other equivalent means. The brace extends from its proximal end connected to the base 12 to the brace distal end 56 defined by the bent portion 60 of the rod. The bent portion 60 of the rod is formed by folding over the intermediate portion of the rod and then folding the bent portion back so that the bent portion 60 projects toward the brace proximal end 54 defined by the opposite ends 58 of the rod. The brace distal end 56 defined by the bent portion 60 of the rod is secured to the first side 40 of the leg support by a weld or other equivalent means. The brace distal end 56 is secured to the leg support 14 intermediate the opposite proximal 32 and distal 34 ends of the leg support with the projection 64 formed by the bent portion 60 being unobstructed by the leg support 14 or the base 12. This positioning of the projection formed by the bent portion 60 provides easy access to the projection for suspending a separate article from the projection, for example suspending an article of clothing or a student's backpack from the projection. In addition, the projection 62 formed by the bent portion of the support brace rod is an integral part of the rod and the brace. Thus, the bent rod of the brace 16 serves the dual functions of reinforcing the connection of the furniture leg support 16 to the base 12 and providing a projection 62 on the furniture leg support for suspending separate articles such as clothing or a student's backpack. In addition, positioning the projection 60 on the inside of the leg support 14 where it is inside the four furniture legs will not adversely effect the stability of the piece of furniture when a heavy object like a full backpack is suspended from the projection.

In the manner set forth above, the construction of the apparatus of the invention provides a furniture leg support that also includes a projection or hook for suspending separate articles from the leg support where a component part of the leg support, i.e. the support brace, serves the dual functions of reinforcing the connection of the leg support to the base and providing a projection for suspending articles from the leg support.

Although the invention has been described above by reference to a preferred embodiment, it should be appreciated that other variations and alterations of the invention may be arrived at without departing from the scope of protection defined by the following claims.

What is claimed is:

1) An apparatus for supporting a furniture leg and for suspending an article from a piece of furniture, the apparatus comprising:
a furniture leg having a length with opposite proximal and distal ends;
a base attached to the furniture leg at the proximal end of the furniture leg, the base having means for attaching the base to a piece of furniture; and,
a support brace having a length with opposite proximal and distal ends, the support brace extending between the furniture leg and the base with the support brace proximal end attached to the base and the support brace distal end attached to the furniture leg, and the support brace having a means for removably suspending a separate article from the support brace.

2) The apparatus of claim 1, further comprising:
the means for suspending a separate article from the support brace comprising a projection that projects outwardly from the support brace in a position that is unobstructed by the furniture leg and the base to enable a separate article to be easily suspended from the projection.

3) The apparatus of claim 2, further comprising:
the projection projecting outwardly from the support brace at the support brace distal end.

4) The apparatus of claim 2, further comprising:
the projection projecting outwardly from the support brace at a position on the furniture leg that is intermediate the furniture leg proximal end and the furniture leg distal end.

5) The apparatus of claim 2, further comprising:
the furniture leg being a tubular leg support having an opening at the leg support distal end to an interior bore of the leg support, and the interior bore being dimensioned to receive a leg section in the interior bore for reciprocating, length adjusting movement of the leg section in the interior bore.

6) The apparatus of claim 5, further comprising:
means on the leg support for securing a leg section received in the interior bore in a length adjusted position in the interior bore.

7) The apparatus of claim 1, further comprising:
the support brace being an elongated rod that is formed in a V-shape with an apex at the support brace distal end and the support brace proximal end being opposite ends of the V-shaped rod.

8) The apparatus of claim 7, further comprising:
the means for suspending a separate article from the support brace being a hook formed in the V-shaped rod at the apex of the V-shape.

9) The apparatus of claim 7, further comprising:
the opposite ends of the V-shaped rod being attached to the base and the apex of the V-shaped rod being attached to the furniture leg.

10) The apparatus of claim 7, further comprising:
the furniture leg having a center axis and the V-shaped rod being symmetric on opposite sides of a plane containing the furniture leg center axis.

11) An apparatus for supporting a furniture leg and for suspending an article from a piece of furniture, the apparatus comprising:
a base having means for attaching the base to a piece of furniture;
a furniture leg having a length with opposite proximal and distal ends, the furniture leg proximal end being attached to the base with the furniture leg projecting outwardly from the base to the furniture leg distal end; and,
a support brace having a length with opposite proximal and distal ends, the support brace proximal end being attached to the base at a position spaced from the furniture leg proximal end and the support brace distal end being attached to the furniture leg at a position spaced from the furniture leg proximal end, and the support brace having a bend at the support brace distal end that defines a projection that projects outwardly from the furniture leg in a position that is unobstructed by the furniture leg and the base, enabling a separate article to be removably suspended from the projection.

12) The apparatus of claim 11, further comprising:
the support brace having a triangular configuration with an apex of the triangular configuration being attached to the furniture leg and a base of the triangular configuration being attached to the base.

13) The apparatus of claim 11, further comprising:
the base being planar and the furniture leg being attached to the base at an angled orientation with the base and furniture leg defining an obtuse angle on a first side of the furniture leg and the base and furniture leg defining an acute angle on an opposite, second side of the furniture leg, and the support brace distal end is attached to the furniture leg on the first side of the furniture leg.

14) The apparatus of claim 11, further comprising:
the support brace being an elongate rod that is attached to the base and the furniture leg.

15) The apparatus of claim 11, further comprising:
the support brace being an elongate rod with opposite ends, the rod being bent in a triangular configuration with a bend in an intermediate portion of the rod defining an apex of the triangular configuration and the opposite ends of the rod defining a base of the triangular configuration, the apex of the triangular configuration being the distal end of the support brace attached to the furniture leg and the opposite ends of the rod being the proximal end of the support brace attached to the base.

16) The apparatus of claim 15, further comprising:
the bend in the intermediate portion of the rod that defines the triangular configuration apex is also the bend that defines the projection.

17) An apparatus for supporting a furniture leg and for suspending an article from a piece of furniture, the apparatus comprising:
a piece of furniture;
a base attached to the piece of furniture;
a leg having a length with opposite proximal and distal ends, the leg proximal end being attached to the base with the leg length projecting outwardly from the base to the leg distal end; and,
a support brace having a length with opposite proximal and distal ends, the support brace proximal end being attached to the base and the support brace distal end being attached to the leg, and the support brace having a projection at the support brace distal end that projects outwardly from the leg in a position that is unobstructed by the leg and the support brace, enabling a separate article to be removably suspended from the projection.

18) The apparatus of claim 17, further comprising:
the leg being a tubular leg support having an interior bore with an opening to the interior bore at the leg support distal end; and
a leg section being received in the interior bore for reciprocating, length adjusting movement of the leg section in the interior bore.

19) The apparatus of claim 18, further comprising:
the support brace being an elongate rod with opposite ends that is formed in a V-shape with a bend in an intermediate portion of the rod forming an apex of the V-shape at the support brace distal end and also forming the projection at the support brace distal end, and the opposite ends of the rod being attached to the base and also forming the support brace proximal end.

20) The apparatus of claim 18, further comprising:
the support brace being an elongate rod with opposite ends, the rod being bent in a triangular configuration with a bend in an intermediate portion of the rod defining an apex of the triangular configuration and the opposite ends of the rod defining a base of the triangular configuration, the apex of the triangular configuration being the distal end of the support brace and defining the projection and the opposite ends of the rod being the proximal end of the support brace.
